(19) United States
(12) Patent Application Publication
(10) Pub. No.: US 2012/0090791 A1
(43) Pub. Date: Apr. 19, 2012

(54) GUMMED TAPE DISPENSER

(76) Inventor: Omar Blanchfield, Rosenberg, TX (US)

(21) Appl. No.: 13/274,505

(22) Filed: Oct. 17, 2011

Related U.S. Application Data
(60) Provisional application No. 61/393,883, filed on Oct. 16, 2010.

(51) Int. Cl. B32B 38/10

(52) U.S. Cl. 156/510

(57) ABSTRACT

A gummed tape dispenser is disclosed. The dispenser includes a chassis adapted to hold a roll of gummed tape, a moistening device and a cutting device. The cutting device and the moistening device may be linearly aligned with the roll of gummed tape. The moistening device may include a fluid reservoir, a pump, a return channel, and a sponge. The cutting device may include a spring-loaded blade and an indentation adapted to ergonomically receive a finger pad when the cutting device is engaged by a user.

### CROSS-REFERENCE TO RELATED APPLICATION

This application claims the benefit of priority of U.S. provisional patent application No. 61/393,883, filed, Oct. 16, 2010, the contents of which are herein incorporated by reference.

### BACKGROUND OF THE INVENTION

The present invention generally relates to office supplies, and more particularly, to a gummed tape dispenser.

Water activated tape (also referred to as gummed tape), is commonly used for sealing packaging, for example. One conventional manner of using and preparing gummed tape is to have a free standing roll of tape, a bottle of water, and scissors handy to wet and cut the tape by hand. This may require a clear area to prepare the gummed tape to wrap the desired item. Wetting the tape on a workman's surface can leave behind sticky residue and exposes the tape to moisture in the air potentially ruining it. This can produce waste and mess because the tape can become saturated on a flat surface like a desk or table where it was prepared.

There also exist industrial sized tape dispensers that pass gummed tape under a wetting brush. Industrial sized tape dispensers may be too bulky for use on an office desk environment. The fluid from the brush may be free flowing causing potential dripping and mess.

Additionally, existing tape dispensers may use a handle repetitively pulled to draw and cut a portion of tape. The repetitive pulling motion of handles can cause fatigue and joint problems in a user.

As can be seen, there is a need for an apparatus that can dispense, moisten, and cut gummed tape while avoiding a mess on a workman's surface. It can also be seen that there is a need for providing a tape dispenser that can minimize joint fatigue in a user.

### SUMMARY OF THE INVENTION

In one aspect of the present invention, tape dispenser comprises a chassis configured to carry a roll of gummed tape; a sponge on the chassis disposed to moisten a gummed side of the tape as the tape passes over the sponge; and a blade disposed on the chassis configured to cut the tape.

In another aspect of the present invention, a tape dispenser comprises a chassis configured to carry a roll of gummed tape; a cutting device disposed in linear alignment with tape dispensed from the roll of gummed tape; an indentation on the cutting device adapted to receive a finger pad; and a moistener device disposed in linear alignment with the cutting device, wherein the cutting device is configured to guide the tape over a surface of the moistener device.

In still yet another aspect of the present invention, a tape dispenser comprises a chassis; a first spindle proximate a first end of the chassis configured to carry a roll of gummed tape; a second spindle on the chassis positioned intermediate the first end of the chassis and a second end of the chassis, the second spindle disposed in linear alignment with tape dispensed from the first spindle; a housing; a blade attached to the housing disposed to cut tape carried from the second spindle; and a sponge proximate the second end of the chassis disposed to moisten a gummed side of the tape as the tape passes over the sponge.

These and other features, aspects and advantages of the present invention will become better understood with reference to the following drawings, description and claims.

### BRIEF DESCRIPTION OF THE DRAWINGS

FIG. 1 is a perspective view of a gummed tape dispenser according to an exemplary embodiment of the present invention;

FIG. 2 is an exploded perspective view of the gummed tape dispenser of FIG. 1;

FIG. 3 is a cross-sectional side view of the gummed tape dispenser of FIG. 1;

FIG. 4 is an enlarged partial, cross-sectional view of an exemplary moistener device used in accordance with an exemplary embodiment of the gummed tape dispenser of FIG. 1;

FIG. 5 is an enlarged partial, cross-sectional view of a return channel on the moistener device of FIG. 4;

FIG. 6 is a top view of the moistener device of FIG. 4 with a sponge removed; and

FIG. 7 is a bottom view of an exemplary sponge used in the gummed tape dispenser of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a tape dispenser providing activated gummed tape while maintaining a clean environment around the dispenser. Aspects of the present invention may provide moisture to the gummed side of tape as the tape is withdrawn for use without manual application of the moisture. In other aspects of the present invention, a user may benefit from quick and repetitive cut and withdrawal of gummed tape by use of an ergonomic cutting device. Still yet, exemplary embodiments of the present invention may provide a gummed tape dispenser that can be affordable for personal use, for example, on an office desk environment.

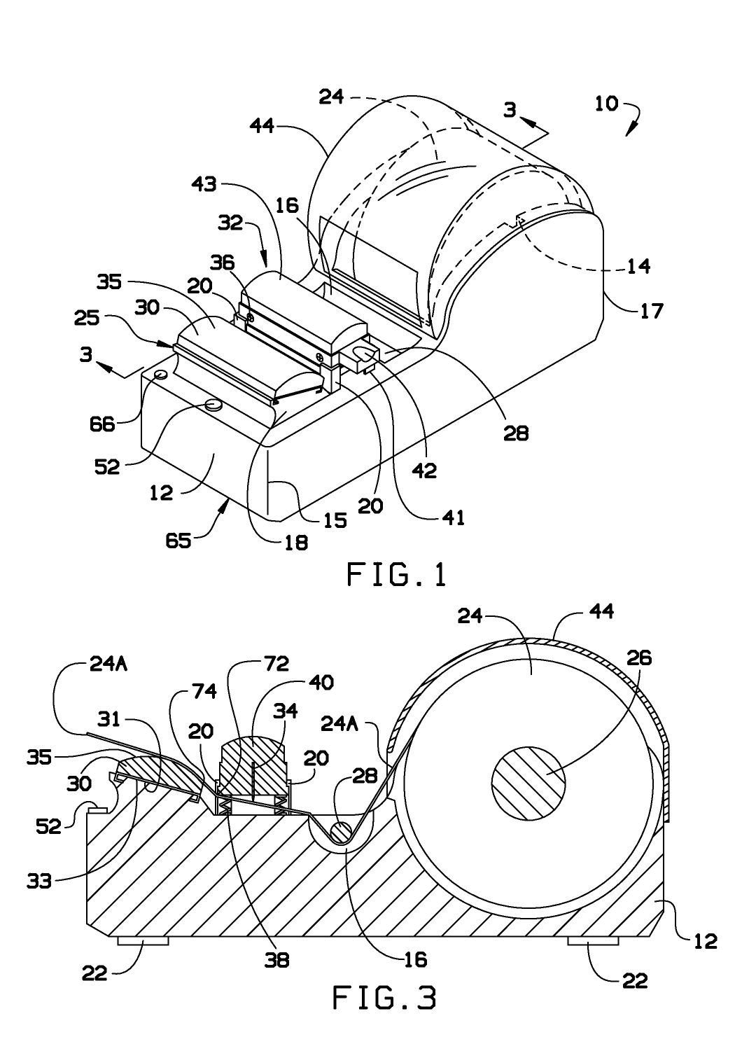

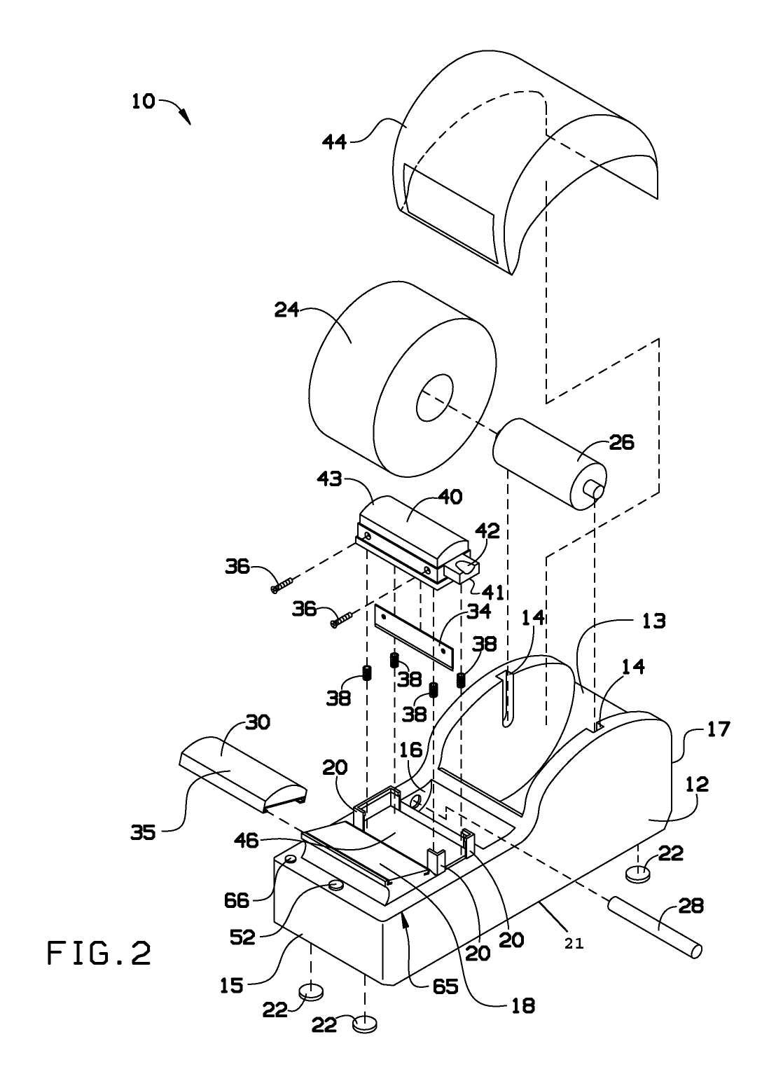

Referring to FIGS. 1-3, a gummed tape dispenser 10 is shown in accordance with an exemplary embodiment of the present invention. The gummed tape dispenser 10 may include a chassis 12, a cutting device 32, and a moistening device 25.

The chassis 12 may include a pair of slots 14 in a tape compartment 13 disposed to carry a spindle 26. The compartment may be proximate a carriage end 17 of the chassis 12. The spindle 26 may be sized to fit within the central opening of a roll of gummed tape 24. A cover 44 may be attached to the chassis 12 covering the roll of gummed tape 24. The cover 44 may be a molded one-piece plastic or other rigid transparent/translucent material. The cover 44 may be configured to snap or press-fit into the chassis 12 over the tape compartment 13. The cover 44, in one aspect, may protect the roll of gummed tape 24 from ambient moisture, wear and tear, or debris. In another aspect, the cover 44 may provide visual access to an amount remaining on the roll of gummed tape 24. The cover 44 may include a window positioned to allow drawn gummed tape 24a to be drawn from the roll 24. A guide compartment 16 in the chassis 12 may be proximate the compartment 13 and disposed to carry a tape guide spindle 28. A set of rubber feet 22 may be attached to an underside 21 of the chassis 12 providing traction onto a workman's surface while protecting the chassis 12.

In one exemplary embodiment, the cutting device 34 may be intermediate the ends 15 and 17 of the chassis 12. The cutting device 32 may include a blade 34 attached to a housing 40 using screws 36. The housing 40 may be configured to travel within a set of guide posts 20 so that the blade 34 may engage drawn gummed tape 24a drawn through spacing within the guide posts 20. A protective plate 46 may be positioned between the guideposts 20 and under the cutting device 32 to protect the underlying chassis 12 from damage inflicted by the blade 34. The protective plate 46 may be metal, for example, stainless steel or aluminum, durable enough to resist impact from the blade 34 over repeated strikes. One or more springs 38 may be coupled between the housing 40 and the protective plate 46 providing spring-loaded actuation of the blade 34 onto the tape 24a. The housing 40 may include a rounded top surface 43. A tab 41 may project out from an end of the housing 40. The tab 41 may include an indentation 42. The indentation 42 may be rounded to approximate the shape of a user's finger pad (not shown).

In one exemplary embodiment, the moistening device 25 may be positioned on a dispensing end 15 of the chassis 12. The moistening device 25 may be disposed in the open-air for ease of access by a user. The moistening device 25 may include a mount 18 disposed on a graded surface 31 angled downward relative to the underside 21 of the chassis 12 so that the moistening device 25 may be disposed tilted relative to the cutting device 32. In one exemplary embodiment, the moistening device 25 may include a sponge 30 disposed to moisten a gummed side of the tape 24a drawn over the moistening device 25.

Referring concurrently to FIG. 5, the sponge 30 may be mounted onto a bracket 33 including guiderails 75 configured for slidable mounting onto slots (not shown) of the mount 18. The sponge 30 may include a channel 70 and an orifice 68 on an underside (See FIG. 7).

Referring back to FIGS. 1-3, the chassis 12 may house a fluid source 65 configured to provide fluid to the moistening device 25. The fluid source 65 may include a refill port 66 and a pump button 52 disposed on the chassis 12 in fluid communication with an interior of the moistening device 25. For sake of illustration, exemplary details of the fluid source 65 including its interior are omitted from FIGS. 1-3 and are described in further detail below.

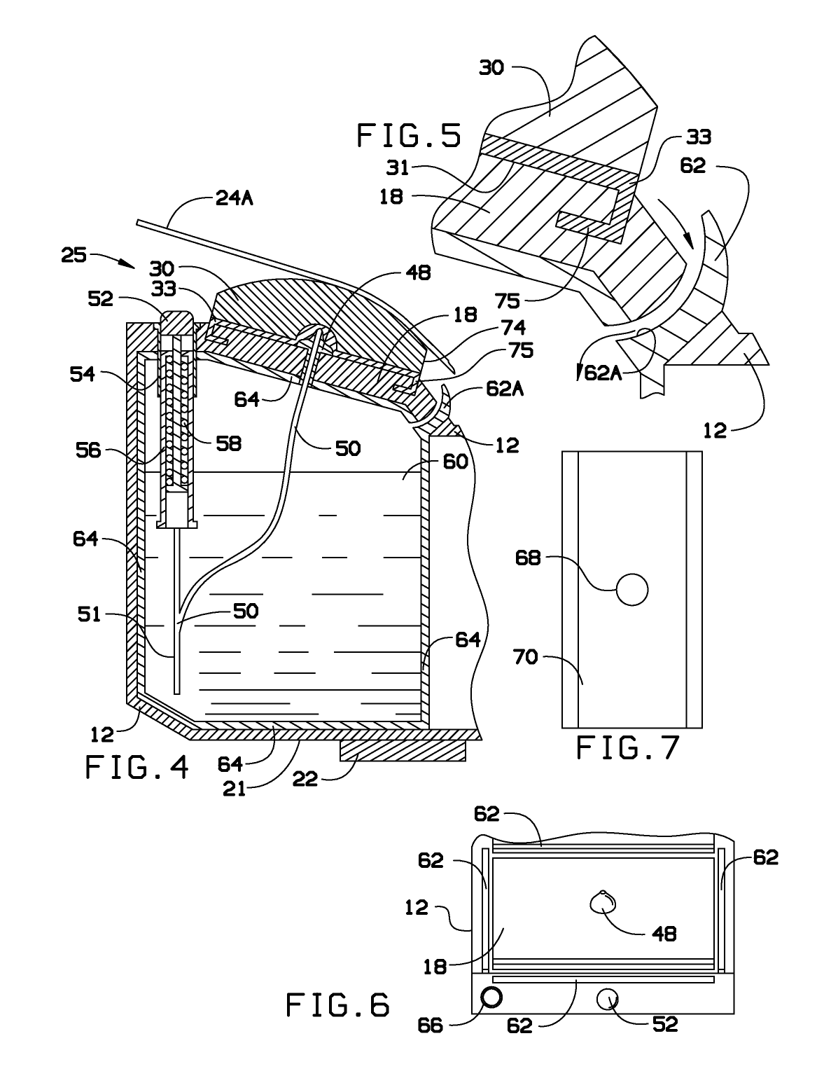

Referring now to FIGS. 4-7, enlarged details of portions of the moistening device 25 are shown. A fluid reservoir 64 may hold fluid 60, for example, water, under the moistening device 25. A pump system 51 may include a fluid hose 50, the pump button 52, a tube assembly 54, a plunger assembly 56, and a spring 58 configured to move the fluid 60 from the reservoir 64 to the sponge 30. The pump button 52 may be coupled to the tube assembly 54 and plunger assembly 56. The fluid hose 50 may be attached at one end to the pump button 52 and at another end to a spout 48. The fluid hose 50 may be bifurcated and include an intake tube 51 intermediate the plunger assembly 56 and the spout 48. The spout 48 may be on the mount 18 disposed in fluid communication with the sponge 30. When the sponge 30 is attached to the mount 18, sponge 30 may slide over the spout 48 which may travel unobstructed through the channel 70 until the spout 48 is under the orifice 68. For sake of illustration, the sponge 30 is removed from view in FIG. 6 to permit view of the underlying spout 48. In one exemplary embodiment, the moistening device 25 may include one or more wall projections 62 surrounding the sponge 30 defining return channels 62a that are in fluid communication with the reservoir 64. The wall projections 62 may be curved and include an upper edge projecting above the mount 18.

Referring to FIGS. 1-3, in an exemplary use of the tape dispenser 10, a user may manually draw the tape 24a out of the cover 44, into the compartment 16 under the tape guide spindle 28, and under the housing 40. A desired length of tape 24a may be visually measured so that the length of tape 24a is pulled up against the trailing edge 72 of the housing 40 so that it meets the leading edge 74 of the sponge 30. The tape 24a may thus be drawn with tension over the top surface 35 of the sponge 30 where moisture may encounter and activate the gummed side of the tape 24a. The user may continue to draw the tape 24a over the sponge 30 until the desired length plus a nominal length has reached the blade 34. Additionally, an angular offset of the sponge 30 from the chassis 12 allows the user to maximize the use of the user's hand and arm movement when they're pulling the gummed tape over the sponge 30, allowing the option of selecting a larger piece of tape 24a to be cut and allowing the user's arm movements to be natural to functions of the human body with little effort.

As the tape 24a is drawn under tension, the disposition of tape 24a over the sponge 30 and under the trailing edge 72 may provide a portion of the tape 24a under the housing 40 to be spaced from the underlying protective plate 46. When the desired length of tape 24a is moistened, a user may engage either the top surface 43 of the housing 40 or the indentation 42 on the tab 41 and may press downward so that the blade 34 cuts through the tape 24a. The protective plate 46 may provide a stop for the blade 34, protecting the underlying chassis 12. Repeated operation of the cutting device 32 may be performed by a user's finger engaged to the easy spring-loaded action of the tab 41.

Referring now to FIGS. 4-7, aspects of the present invention may moisten the sponge 30 while maintaining a clean environment. The sponge 30 may be either removed from the mount 18 and saturated manually by an external source (not shown) or may be moistened by the moistening device 25. For example, fluid such as water may be filled into the reservoir 64 through the refill port 66. Fluid in the sponge 30 may be replenished by pressing the pump button 52 causing the spring 58 to displace water in the pump assembly 56 creating a momentary vacuum. Release of the pump button 52 may cause water in the reservoir 64 to be sucked up and into the intake tube 51 where at least some of the sucked up water may be diverted toward the spout 48. The spout 48 may spray water out into the orifice 68 distributing water into the sponge 30.

As a user engages that tape 24a against the sponge 30, water may activate the gummed side. In the event of oversaturation, excess fluid may flow downward toward and over the leading edge 74 of the sponge 30 where it may be captured by the projection wall 62 and may flow back into the reservoir 64 via return channel 62a. In exemplary embodiments including multiple return channels 62a, excess fluid seeping over any side of the sponge 30 may be captured by surrounding projection walls 62.

It should be understood, of course, that the foregoing relates to exemplary embodiments of the invention and that modifications may be made without departing from the spirit and scope of the invention as set forth in the following claims. For example, it will be understood that although the tab 41 (FIGS. 1-3) is shown attached to the housing 40 on the right side, that exemplary embodiments may also include the tab 41 on the left side of the housing for ease of use during either right or left handed operation.

Additionally, while a sponge 30 has been described, other membranous water absorbent materials may be used instead.

What is claimed is:

1. A tape dispenser, comprising:
a chassis configured to carry a roll of gummed tape;
a sponge on the chassis disposed to moisten a gummed side of the tape as the tape passes over the sponge; and
a blade disposed on the chassis configured to cut the tape.

2. The tape dispenser of claim 1, wherein the sponge is disposed on a grade and configured to contact the gummed side of the tape under tension.

3. The tape dispenser of claim 1 further comprising a pump and a fluid reservoir configured to provide fluid to the sponge.

4. The tape dispenser of claim 3 further comprising a spout under the sponge disposed to provide fluid to the sponge, the spout coupled to the pump and fluid reservoir.

5. The tape dispenser of claim 4 further comprising a wall projecting below the sponge, the wall defining a return channel in fluid communication with the fluid reservoir.

6. A tape dispenser, comprising:
a chassis configured to carry a roll of gummed tape;
a cutting device disposed in linear alignment with tape dispensed from the roll of gummed tape;
an indentation on the cutting device adapted to receive a finger pad; and
a moistener device disposed in linear alignment with the cutting device, wherein the cutting device is configured to guide the tape over a surface of the moistener device.

7. The tape dispenser of claim 6, wherein the cutting device is intermediate the roll of gummed tape and the fluid applicator

8. The tape dispenser of claim 6, wherein the cutting device is attached to a spring-loaded housing.

9. The tape dispenser of claim 8 wherein the indentation is on a tab projecting from an end of the spring-loaded housing.

10. A tape dispenser, comprising:
a chassis;
a first spindle proximate a first end of the chassis configured to carry a roll of gummed tape;
a second spindle on the chassis positioned intermediate the first end of the chassis and a second end of the chassis, the second spindle disposed in linear alignment with tape dispensed from the first spindle;
a housing;
a blade attached to the housing disposed to cut tape carried from the second spindle; and
a sponge proximate the second end of the chassis disposed to moisten a gummed side of the tape as the tape passes over the sponge.

11. The tape dispenser of claim 10 wherein the housing is spring-loaded.

12. The tape dispenser of claim 10 wherein:
the housing includes a trailing edge; and
the sponge includes a leading edge, wherein
the trailing edge and the leading edge are configured to provide a tension to tape disposed between the trailing edge and the leading edge.

13. The tape dispenser of claim 10 wherein the sponge is mounted on a graded surface relative to a chassis underside.

14. The tape dispenser of claim 13 further comprising a wall defining a return channel disposed below the sponge, the wall disposed to capture excess fluid from the sponge.

15. The tape dispenser of claim 14 further comprising a fluid reservoir and a pump coupled to the sponge, the pump and fluid reservoir configured to provide fluid to the sponge.
